(19) United States
(12) Patent Application Publication
(10) Pub. No.: US 2020/0403357 A1
(43) Pub. Date: Dec. 24, 2020

(54) CONNECTOR

(71) Applicant: Mitsubishi Electric Corporation, Tokyo (JP)

(72) Inventors: Yudai YONEOKA, Tokyo (JP); Yoshiaki IRIFUNE, Tokyo (JP); Norihiko AKASHI, Tokyo (JP); Masaomi WASHINO, Tokyo (JP)

(73) Assignee: Mitsubishi Electric Corporation, Tokyo (JP)

(21) Appl. No.: 16/476,308

(22) PCT Filed: May 11, 2018
(86) PCT No.: PCT/JP2018/018370

§ 371 Date: Jul. 8, 2019

(51) Int. Cl. H01R 13/719; H01R 12/72; H01R 13/6581; H01R 24/64; H01R 13/66

(52) U.S. Cl. CPC H01R 13/719; H01R 12/724; H01R 13/6625; H01R 24/64; H01R 13/6633; H01R 13/6581

(57) ABSTRACT

A connector includes a first connector housing, a second connector housing, and a first capacitor. The first connector housing includes a first connection terminal connected with a frame ground pattern, and a first capacitor connection part located closer to a plug housing connection part than a top face of the first connector housing. The second connector housing includes a transformer or a common mode choke coil, a second connection terminal connected with a signal ground pattern, and a second capacitor connection part located closer to the second connection terminal than the position where the transformer or the common mode choke coil is placed. The first capacitor connects the first capacitor connection part with the second capacitor connection part.

### FIELD

The present invention relates to a connector with which a communication cable is connected.

### BACKGROUND

In recent years, with the advance of miniaturization, high-density packaging, and also voltage reduction of electronic devices, it is increasingly difficult to ensure the noise resistance performance of printed circuit boards. In these circumstances, there have been demands for ensuring noise resistance performance as required in specifications while satisfying implementation constraints and suppression cost constraints. With the recent increase in IoT (Internet of Things) devices, the number of connections between devices and between devices and networks is growing explosively. Devices that need real-time control need to be connected with control devices via communication cables, and controlled by the control devices. Connectors with which communication cables are connected are therefore essential, and there have been more demands for enhancement of noise resistance performance inside a connector than ever.

In related art, for connectors, methods for reducing noise by using a common mode choke coil or a transformer have been proposed. For example, a connector in which a noise suppression component accommodated in a resin case for preventing spreading of electromagnetic noise to the outside and a common mode choke coil are covered by a metal housing is proposed (refer, for example, to Patent Literature 1). The metal housing is a connector housing.

### CITATION LIST

### Patent Literature

Patent Literature 1: Japanese Patent Application Laid-open No. 2017-27675

### SUMMARY

### Technical Problem

The technique of covering the noise suppression component and the common mode choke coil with the metal housing is effective for preventing spreading of noise from communication signal lines inside the connector to the outside of the connector. Noise output from a communication cable, however, is propagated from the metal housing to the inside of the connector via the stray capacitance of the noise suppression component and the common mode choke coil, and there have therefore been demands for measures against noise propagated from the metal housing into the inside of the connector. Noise propagated into the inside of the connector is propagated to the communication signal lines. There have therefore been demands for providing a connector that reduces noise propagated from a connector housing to communication signal lines.

The present invention has been made in view of the above, and an object thereof is to provide a connector capable of reducing noise propagated to communication signal lines through connector housings.

### Solution to Problem

To solve the aforementioned problems and achieve the object, the present invention includes: a first connector housing including a plug housing connection part with which a plug housing part of a communication cable plug is connected, a first connection terminal connected with a frame ground pattern provided on a circuit board, and a first capacitor connection part located closer to the plug housing connection part than a top face and provided with the first connection terminal; and a transformer or a common mode choke coil. The present invention further includes: a second connector housing separated from the first connector housing and, including a second connection terminal connected with a signal ground pattern provided on the circuit board, and a second capacitor connection part located closer to the second connection terminal than a position where the transformer or the common mode choke coil is placed and provided with the second connection terminal; and a first capacitor that connects the first capacitor connection part of the first connector housing with the second capacitor connection part of the second connector housing. The top face is a top face of the first connector housing. The transformer or the common mode choke coil is placed inside the second connector housing.

### Advantageous Effects of Invention

A connector according to the present invention produces an effect of reducing noise propagated from a connector housing to communication signal lines.

### BRIEF DESCRIPTION OF DRAWINGS

FIG. 1 is a perspective view schematically illustrating a connector according to a first embodiment.

FIG. 2 is an exploded perspective view of the connector according to the first embodiment.

FIG. 3 is a diagram schematically illustrating a cross section of the connector according to the first embodiment.

FIG. 4 is a plan view of a capacitor connection board on which a first capacitor of the connector according to the first embodiment is provided.

FIG. 5 is a diagram illustrating an example of a state in which a first connector housing and a second connector housing are connected with each other by the first capacitor of the connector according to the first embodiment.

FIG. 6 is a diagram schematically illustrating a front of a connector according to a second embodiment.

FIG. 7 is a diagram schematically illustrating a cross section of a connector according to a third embodiment.

FIG. 8 is a diagram schematically illustrating a rear face of the connector according to the third embodiment.

FIG. 9 is a diagram schematically illustrating a plan of a connection board of the connector according to the third embodiment.

FIG. 10 is a diagram schematically illustrating a side of the connection board of the connector according to the third embodiment.

FIG. 11 is a perspective view schematically illustrating a connector according to a fourth embodiment.

FIG. 12 is an exploded perspective view of the connector according to the fourth embodiment.

FIG. 13 is an exploded perspective view of a connector according to a fifth embodiment.

FIG. 14 is a diagram schematically illustrating a front view of a first connector housing of the connector according to the fifth embodiment.

FIG. 15 is a perspective view schematically illustrating a connector according to a sixth embodiment.

FIG. 16 is an exploded perspective view of the connector according to the sixth embodiment.

FIG. 17 is an exploded perspective view of a connector according to a seventh embodiment.

FIG. 18 is a diagram schematically illustrating a front of the connector according to the seventh embodiment.

FIG. 19 is a diagram schematically illustrating a rear of a first resin housing of the connector according to the seventh embodiment.

### DESCRIPTION OF EMBODIMENTS

A connector according to certain embodiments of the present invention will be described in detail below with reference to the drawings. Note that the present invention is not limited to the embodiments.

### First Embodiment

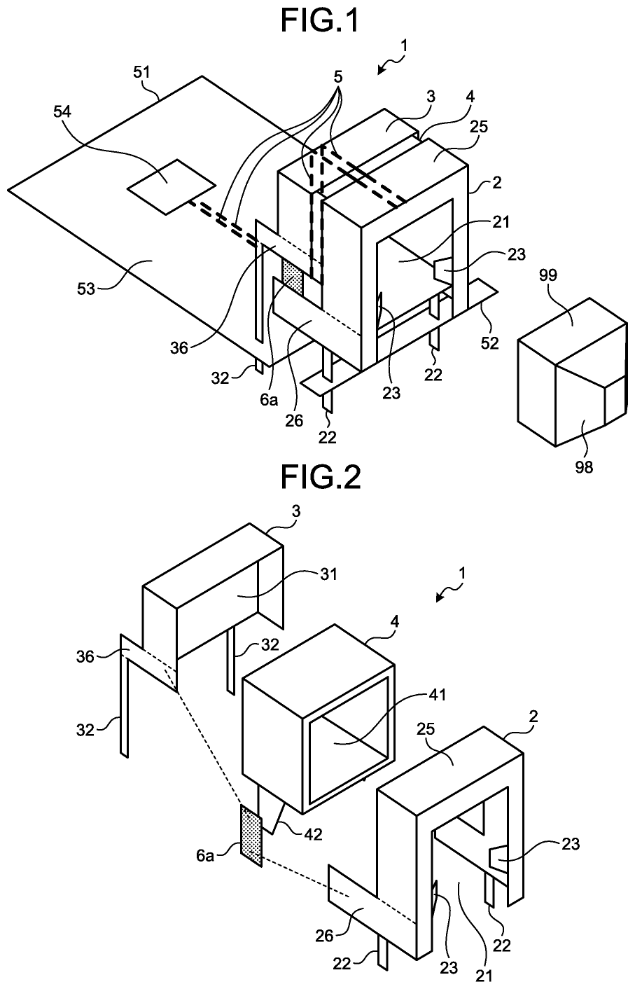

FIG. 1 is a perspective view schematically illustrating a connector 1 according to a first embodiment. FIG. 2 is an exploded perspective view of the connector 1 according to the first embodiment. FIG. 2 schematically illustrates a state in which the connector 1 is decomposed. The connector 1 includes a first connector housing 2, and a second connector housing 3 that is separate from the first connector housing 2. The second connector housing 3 is away from the first connector housing 2. Note that, for clarification of explanation, some components are hatched and others are not hatched in the drawings of the present application.

Both of the first connector housing 2 and the second connector housing 3 are made of conductive materials. In FIGS. 1 and 2, both of the first connector housing 2 and the second connector housing 3 are schematically illustrated in a state in which the first connector housing 2 and the second connector housing 3 are formed by bending metal sheets. Examples of the metal include aluminum and stainless steel. The first connector housing 2 has an opening 21. The opening 21 is a through-hole. The second connector housing 3 has an opening 31.

The connector 1 further includes a first resin housing 4. Both of the first connector housing 2 and the second connector housing 3 are located on an outer side of the first resin housing 4 in such a manner that the first connector housing 2 and the second connector housing 3 are not in contact with each other. Furthermore, the first connector housing 2 and the second connector housing 3 are located on the outer side of the first resin housing 4 in such a manner that the first connector housing 2 and the second connector housing 3 cover the first resin housing 4 except for a part of first resin housing 4. For example, in a case where a projection is provided on the first resin housing 4, one or both of the first connector housing 2 and the second connector housing 3 may have a member that prevents a shift in position by using the projection provided on the first resin housing 4.

The first connector housing 2 includes first connection terminals 22 connected with a frame ground pattern 52 provided on a circuit board 51. The second connector housing 3 includes second connection terminals 32 connected with a signal ground pattern 53 provided on the circuit board 51. FIG. 1 also illustrates the circuit board 51, the frame ground pattern 52, and the signal ground pattern 53. For example, the first connection terminals 22 are inserted in openings formed in the circuit board 51, and electrically connected with the frame ground pattern 52 by soldering. For example, the second connection terminals 32 are inserted in openings formed in the circuit board 51, and electrically connected with the signal ground pattern 53 by soldering.

The frame ground pattern 52 is connected in series with a housing in which a control panel is accommodated or a ground of a building, for example. The signal ground pattern 53 is separated from the frame ground pattern 52. The reason for which the signal ground pattern 53 is separated from the frame ground pattern 52 is to prevent malfunction of a device or a component connected with the circuit board 51 when noise of a relatively high voltage or a relatively large current is supplied to the device or the component, and to prevent failure of the device or the component. An example of the noise of a relatively high voltage or a relatively large current is lightning surge noise.

In a frequency band of several MHz or lower, the impedance from the frame ground pattern 52 to the signal ground pattern 53 needs to be several tens Q or higher. The signal ground pattern 53 is thus separated from the frame ground pattern 52. In a relatively high frequency band of several tens to several hundred MHz, for example, however, the impedance from the frame ground pattern 52 to the signal ground pattern 53 needs to be relatively low.

Noise in a relatively high frequency band of several tens to several hundreds MHz, for example, is caused by capacitance between the windings of a transformer or a common mode choke coil, and has characteristics of being easily transmitted. As the frequency is higher, the amount of noise propagation tends to increase. FIG. 1 also illustrates communication signal lines 5. The communication signal lines 5 are provided inside the first connector housing 2 and the second connector housing 3. The communication signal lines 5 are also provided on the first resin housing 4 and the circuit board 51. The transformer and the common mode choke coil are located inside the second connector housing 3. The transformer and the common mode choke coil will also be described later.

When the frame ground pattern 52 and the signal ground pattern 53 are electrically insulated, the whole noise propagated to the frame ground pattern 52 is propagated to the communication signal lines 5. Thus, the influence of the noise on the aforementioned device or component is relatively large. A first capacitor 6a that makes the impedance from the frame ground pattern 52 to the signal ground pattern 53 be a relatively high impedance of several tens Ω or higher in a frequency band of several MHz, and a relatively low impedance of 1Ω or lower in a frequency band of several tens to several hundred MHz, for example, is therefore used. Thus, the connector 1 further includes the first capacitor 6a.

The first capacitor 6a is an element that connects the frame ground pattern 52 with the signal ground pattern 53. As described above, the first connector housing 2 is connected with the frame ground pattern 52, and the second connector housing 3 is connected with the signal ground pattern 53. The first capacitor 6a connects the first connector housing 2 with the second connector housing 3. The first capacitor 6a thus connects the frame ground pattern 52 with the signal ground pattern 53.

The first capacitor 6a is preferably a ceramic capacitor with which no lead terminal is connected, for example. The first capacitor 6a has induction characteristics, that is, characteristics of an inductor, and the size of the first capacitor 6a relates to the magnitude of the impedance. The first capacitor 6a is therefore preferably relatively small with vertical and horizontal lengths of several mm.

The first connector housing 2 and the second connector housing 3 are separated from each other by a distance of several mm, for example. The first connector housing 2 further includes a plug housing connection part 23 with which a plug housing part 99 of a communication cable plug 98 is connected. FIG. 1 also illustrates the communication cable plug 98. The plug housing part 99 of the communication cable plug 98 is inserted into an inside of the connector 1 from the end side on which the plug housing connection part 23 is provided.

The first resin housing 4 may be partially coated with a conductive material. The first resin housing 4 has an opening 41 into which the communication cable plug 98 can be inserted. The first resin housing 4 has a projection 42 for fixing the first resin housing 4 to the circuit board 51. For example, the projection 42 is inserted in an opening of the circuit board 51, so that the first resin housing 4 is attached to the circuit board 51. This prevents the position of the first resin housing 4 from being shifted. The communication signal lines 5 are also provided inside the first resin housing 4. The communication signal lines 5 provided in the first connector housing 2, the first resin housing 4, and the second connector housing 3, and on the circuit board 51 are connected with each other.

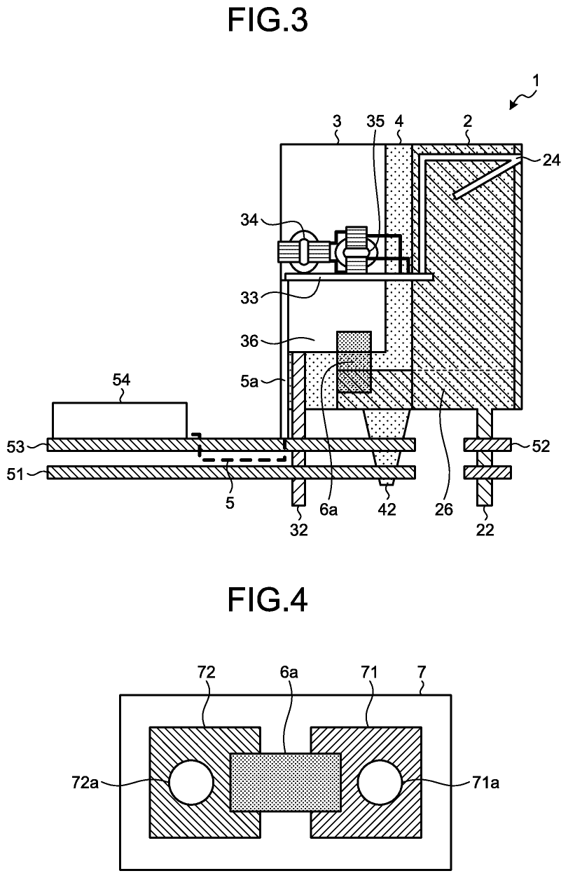

FIG. 3 is a diagram schematically illustrating a cross section of the connector 1 according to the first embodiment. The connector 1 further includes a connection board 33 located inside the second connector housing 3. The connection board 33 is a board for connecting a contact terminal 24 for connecting the communication signal lines of the communication cable plug with the communication signal lines 5 of the connector 1, with the communication signal lines 5 of the connector 1. The contact terminal 24 is provided inside the first connector housing 2. The contact terminal 24 is made of a conductive member.

A transformer 34 and a common mode choke coil 35 around which the communication signal lines 5 are wound are provided on the connection board 33. Thus, the connector 1 includes the transformer 34 and the common mode choke coil 35. The transformer 34 and the common mode choke coil 35 are connected with each other in series. Note that at least one of the transformer 34 and the common mode choke coil 35 may be provided on the connection board 33. In other words, the connector 1 includes at least one of the transformer 34 and the common mode choke coil 35. Communication signal lines 5 are also provided on the connection board 33.

The communication signal lines 5 of the connection board 33 and the communication signal lines 5 of the circuit board 51 are electrically connected with each other via a signal connection terminal 5a. For example, the communication signal lines 5 on the connection board 33 and the signal connection terminal 5a are connected with each other by soldering. For example, the communication signal lines 5 on the circuit board 51 and the signal connection terminal 5a are connected with each other by soldering. The signal connection terminal 5a is an electrically conductive element. An integrated circuit 54 for communication is connected with one, which is not connected with the signal connection terminal 5a, of two ends of each of the communication signal lines 5 on the circuit board 51.

FIG. 3 illustrates an example of the arrangement of the contact terminal 24 and the signal connection terminal 5a. The arrangement of the contact terminal 24 and the signal connection terminal 5a is not limited to the example illustrated in FIG. 3.

As illustrated in FIGS. 1, 2, and 3, the first connector housing 2 has a first capacitor connection part 26 located closer to the plug housing connection part 23 than a top face 25 of the first connector housing 2. The top face 25 is the uppermost face of the connector 1 in the vertical direction when the circuit board 51 is placed on a horizontal surface and the connector 1 is placed on the circuit board 51 in a state in which the first connection terminals 22 and the second connection terminals 32 are connected with the circuit board 51. The first connection terminals 22 are provided at the first capacitor connection part 26. The second connector housing 3 includes a second capacitor connection part 36 located on the side of the second connection terminals 32 with respect to the positions of the transformer 34 and the common mode choke coil 35. The second connection terminals 32 are provided at the second capacitor connection part 36.

Part of the first capacitor connection part 26 is located in a space formed by the second capacitor connection part 36 and the circuit board 51 when the connector 1 is mounted on the circuit board 51. The first capacitor 6a connects the first capacitor connection part 26 with the second capacitor connection part 36. Thus, the first capacitor 6a connects the first connector housing 2 with the second connector housing 3.

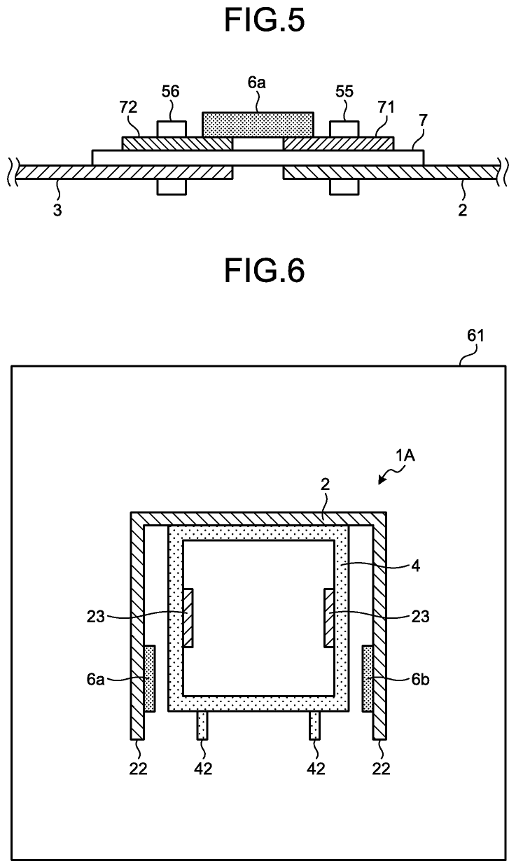

FIG. 4 is a plan view of a capacitor connection board 7 on which the first capacitor 6a of the connector 1 according to the first embodiment is provided. FIG. 5 is a diagram illustrating an example of a state in which the first connector housing 2 and the second connector housing 3 are connected with each other by the first capacitor 6a of the connector 1 according to the first embodiment. In the first embodiment, as illustrated in FIGS. 4 and 5, the capacitor connection board 7 is used, and the first connector housing 2 and the second connector housing 3 are connected with each other by the first capacitor 6a. As illustrated in FIG. 4, the capacitor connection board 7 includes a frame ground pattern 71 and a signal ground pattern 72. The first capacitor 6a connects the frame ground pattern 71 and the signal ground pattern 72 with each other.

The frame ground pattern 71 has an opening 71a for connecting the frame ground pattern 71 with the first connector housing 2, and the signal ground pattern 72 has an opening 72a for connecting the signal ground pattern 72 with the second connector housing 3. A screw of a first fastening member 55 is inserted in the opening 71a, and the screw and a nut of the first fastening member 55 are used to connect the capacitor connection board 7 with the first connector housing 2. A screw of a second fastening member 56 is inserted in the opening 72a, and the screw and a nut of the second fastening member 56 are used to connect the capacitor connection board 7 with the second connector housing 3.

Alternatively, the frame ground pattern 71 may be provided with a first pad, the signal ground pattern 72 may be provided with a second pad, and the first pad may be connected with the first connector housing 2 and the second pad may be connected with the second connector housing 3 by soldering or contact pressure. Still alternatively, a conductive holder may be located at a terminal part of the first capacitor 6a, and the capacitor connection board 7 may be connected with each of the first connector housing 2 and the second connector housing 3 via the holder.

Because the first capacitor 6a connects the first connector housing 2 and the second connector housing 3 with each other, a low impedance path in a relatively high frequency band can be designed at the position of the first capacitor 6a. Specifically, noise entering the connector 1 through the plug housing connection part 23 of the first connector housing 2 is likely to be propagated to the signal ground pattern 53 via the first capacitor 6a. Therefore, the amount of noise propagated to the communication signal lines 5 is relatively small.

Thus, the connector 1 according to the first embodiment is capable of reducing the amount of noise that is propagated to communication signal lines inside an integrated connector housing of the prior art via stray capacitance. In other words, the connector 1 is capable of reducing noise propagated through the first connector housing 2 and the second connector housing 3 to the communication signal lines 5. Note that the integrated connector housing of the prior art does not include a first connector housing 2 and a second connector housing 3 separated from the first connector housing 2.

Furthermore, the connector 1 includes the first connector housing 2, the second connector housing 3 that is separate from the first connector housing 2, and the first capacitor 6a that connects the first connector housing 2 with the second connector housing 3. The connector 1 is therefore capable of making the impedance in a relatively high frequency band from the first connector housing 2 to the signal ground pattern 53 lower than that in the prior art.

As described above, the connector 1 is capable of reducing the amount of noise propagated through the plug housing connection part 23 to the communication signal lines 5 as compared with the prior art. The connector 1 is therefore capable of lowering the influence of noise on a device or a component connected with the circuit board 51 as compared with the prior art.

Assume a case where the first connector housing 2 is brought into contact with the housing in which the control panel is accommodated or the ground of the building by using a metal sheet. In this case, the distance between the first connector housing 2 and the housing or the ground is made as short as possible and the area of the metal sheet is made as large as possible, so that the impedance in a relatively high frequency band from the first connector housing 2 to the housing or the ground is relatively small. Therefore, the amount of noise propagated to the communication signal lines 5 is relatively small.

Furthermore, because the connector 1 includes the first capacitor 6a, the area of a part where the components of the circuit board 51 are mounted is larger than that in the prior art. In other words, the connector 1 enables more components to be mounted on the circuit board 51 than that in the prior art.

In the connector 1, noise is propagated from the first connector housing 2 to the frame ground pattern 52 via the first connection terminals 22. Thus, the connector 1 is capable of reducing the amount of noise propagated to the inside of the connector 1 as compared with the prior art. The transformer 34 and the common mode choke coil 35 are capable of reducing the amount of noise propagated to the communication signal lines 5 wound around the transformer 34 and the common mode choke coil 35 as compared with the prior art. Thus, the connector 1 is capable of reducing the amount of noise propagated to the communication signal lines 5 as compared with the prior art.

### Second Embodiment

FIG. 6 is a diagram schematically illustrating a front of a connector 1A according to a second embodiment. The connector 1A includes the first connector housing 2 and the second connector housing 3, which are included in the connector 1 according to the first embodiment. The second connector housing 3 is not illustrated in FIG. 6. While the connector 1 includes only the first capacitor 6a, the connector 1A includes the first capacitor 6a and a second capacitor 6b. The second embodiment is different from the first embodiment in this regard. In the second embodiment, the difference from the first embodiment will be mainly described.

The first capacitor 6a is the same as the first capacitor 6a included in the connector 1 according to the first embodiment. The second capacitor 6b connects the first connector housing 2 with the second connector housing 3, in a manner similar to the first capacitor 6a.

Because the connector 1A includes two capacitors, which are the first capacitor 6a and the second capacitor 6b, the connector 1A can make the impedance at a relatively high frequency relatively small while noise propagated from the plug housing connection part 23 into the connector 1A is propagated to the communication signal lines 5 provided on the circuit board 51 as compared with the connector 1 including only one capacitor 6a. As a result, the amount of noise propagated from the first connector housing 2 to the signal ground pattern 53 increases, which makes the amount of noise propagated to the communication signal lines 5 relatively small, and thus improves noise resistance performance. This effect is higher as the number of capacitors connected between the first connector housing 2 and the second connector housing 3 is larger. The connector 1A may include three or more capacitors connecting the first connector housing 2 with the second connector housing 3.

Note that the positions of the first capacitor 6a and the second capacitor 6b of the connector 1A are not limited to those illustrated in FIG. 6.

### Third Embodiment

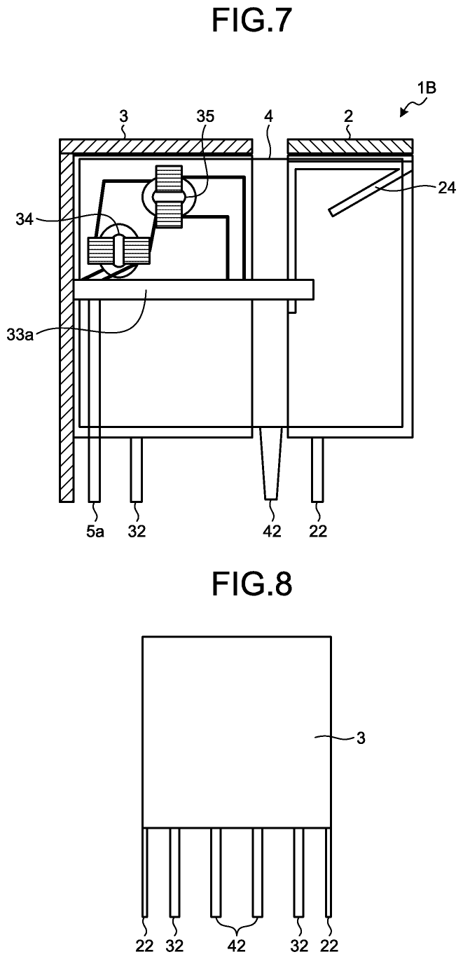

FIG. 7 is a diagram schematically illustrating a cross section of a connector 1B according to a third embodiment. The connector 1B includes the first connector housing 2 and the second connector housing 3, which are included in the connector 1 according to the first embodiment. The connector 1B includes a connection board 33a instead of the connection board 33 of the connector 1. The connection board 33a is located inside the second connector housing 3. FIG. 8 is a diagram schematically illustrating a rear face of the connector 1B according to the third embodiment. The rear face of the connector 1B is a face including an end, into which the plug housing part of the communication cable plug of the connector 1B is not inserted, of two ends in the direction in which the plug housing part is inserted.

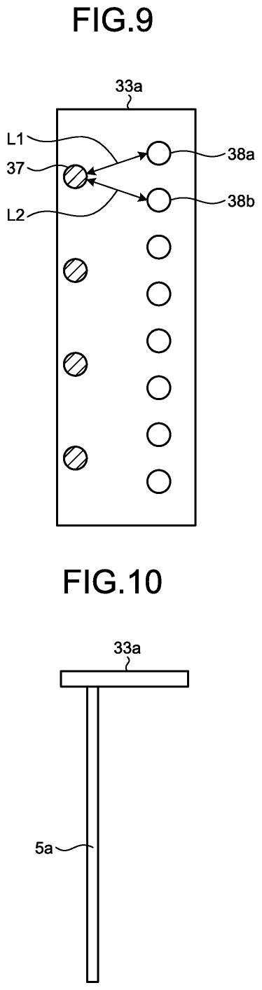

FIG. 9 is a diagram schematically illustrating a plan of the connection board 33a of the connector 1B according to the third embodiment. FIG. 10 is a diagram schematically illustrating a side of the connection board 33a of the connector 1B according to the third embodiment. The connection board 33a is a board for connecting the contact terminal 24 with the signal connection terminal 5a. The signal connection terminal 5a is a connection terminal of the communication signal lines 5 on the circuit board 51.

The connection board 33a is provided with a third connection terminal 37 with which the second connector housing 3 is connected. The connection board 33a further has a first communication signal line opening 38a and a second communication signal line opening 38b with which the signal connection terminal 5a is connected. The distance L1 between the third connection terminal 37 and the first communication signal line opening 38a is equal to the distance L2 between the third connection terminal 37 and the second communication signal line opening 38b.

As described above, in the connector 1B according to the third embodiment, the distance L1 between the third connection terminal 37 and the first communication signal line opening 38a is equal to the distance L2 between the third connection terminal 37 and the second communication signal line opening 38b. Thus, the connector 1B is capable of making the amount of noise propagated to the signal connection terminal 5a connected with the first communication signal line opening 38a equal to the amount of noise propagated to the signal connection terminal 5a connected with the second communication signal line opening 38b. In other words, the connector 1B is capable of making the amount of noise in a differential mode relatively small.

Note that the arrangement of the third connection terminal 37, the first communication signal line opening 38a, and the second communication signal line opening 38b is not limited to that in the example illustrated in FIG. 9. In addition, a plurality of connection boards may be provided instead of the connection board 33a in the connector 1B. In a case where a plurality of connection boards are provided in the connector 1B, the transformer 34 and the common mode choke coil 35 may be provided on one of the connection boards, and the contact terminal 24 may be connected with another one of the connection boards.

### Fourth Embodiment

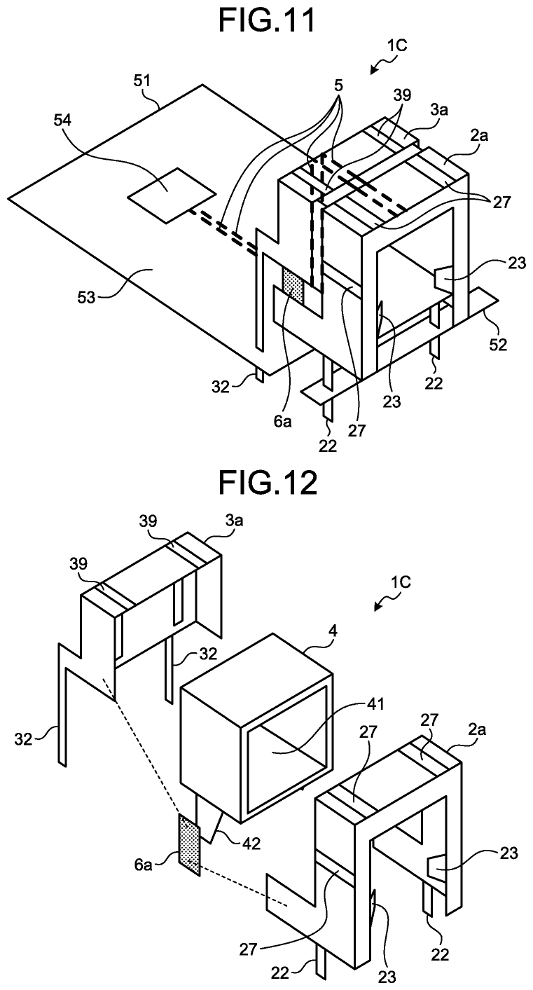

FIG. 11 is a perspective view schematically illustrating a connector 1C according to a fourth embodiment. FIG. 12 is an exploded perspective view of the connector 1C according to the fourth embodiment. FIG. 12 schematically illustrates a state in which the connector 1C is decomposed. The connector 1C includes a first connector housing 2a and a second connector housing 3a. The first connector housing 2a is a housing corresponding to the first connector housing 2 of the first embodiment but having first openings 27. The second connector housing 3a is a housing corresponding to the second connector housing 3 of the first embodiment but having second openings 39.

The first openings 27 are located between the positions of the communication signal lines 5 in the first connector housing 2a and the position of the plug housing connection part 23. The second openings 39 are located between the positions of the communication signal lines 5 in the second connector housing 3a and the second capacitor connection part 36.

In the connector 1C, the first connector housing 2a has the first openings 27. Thus, the impedance in a relatively high frequency band from the plug housing connection part 23 to the communication signal lines 5 in the first connector housing 2a can be increased. The connector 1C is therefore capable of reducing the amount of noise propagated from the plug housing connection part 23 to the communication signal lines 5 in the first connector housing 2a as compared with the amount of noise propagated from the plug housing connection part 23 to the communication signal lines 5 in the first connector housing 2 in the first embodiment.

In the connector 1C, the second connector housing 3a has the second openings 39. Thus, the impedance in a relatively high frequency band from the second capacitor connection part 36 to the communication signal lines 5 in the second connector housing 3a can be increased. The connector 1C is therefore capable of reducing the amount of noise propagated to the communication signal lines 5 in the second connector housing 3a as compared with the amount of noise propagated to the communication signal lines 5 in the second connector housing 3 in the first embodiment.

Note that the sizes of the first openings 27, the number of the first openings 27, and the positions of the first openings 27 are not limited to those in the example illustrated in FIGS. 11 and 12. The sizes of the second openings 39, the number of the second openings 39, and the positions of the second openings 39 are not limited to those in the example illustrated in FIGS. 11 and 12, either. Furthermore, only either of the first openings 27 and the second openings 39 may be provided.

### Fifth Embodiment

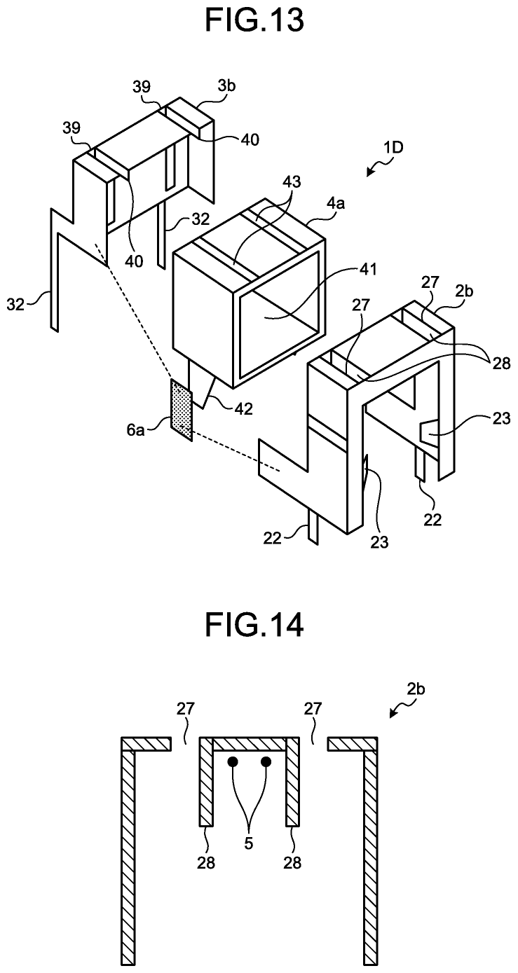

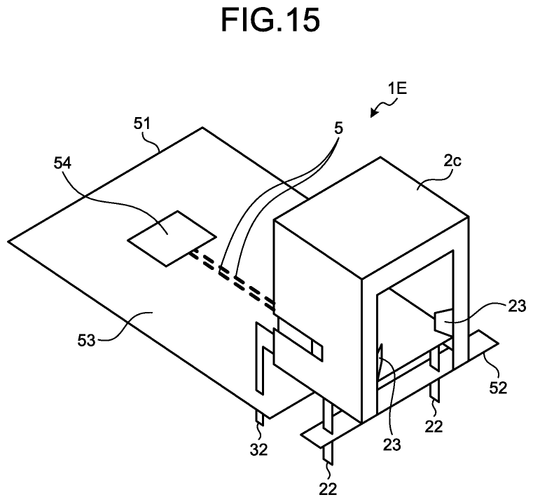

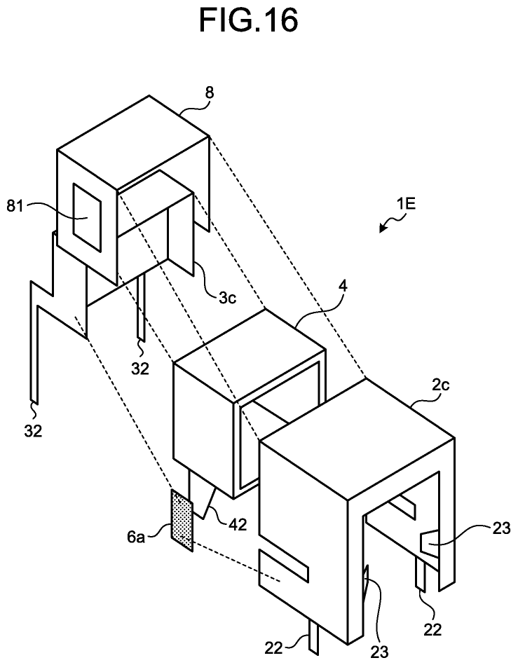

FIG. 13 is an exploded perspective view of a connector 1D according to a fifth embodiment. FIG. 13 schematically illustrates a state in which the connector 1D is decomposed. FIG. 14 is a diagram schematically illustrating a front of a first connector housing 2b of the connector 1D according to the fifth embodiment. The connector 1D includes the first connector housing 2b, a second connector housing 3b, and a first resin housing 4a.

The first connector housing 2b is a housing corresponding to the first connector housing 2a of the fourth embodiment, but having a top face part provided with first shield parts 28 extending to the inside of the first connector housing 2a from outer edges of the first openings 27. The second connector housing 3b is a housing corresponding to the second connector housing 3a of the fourth embodiment, but having a top face part provided with second shield parts 40 extending to the inside of the second connector housing 3a from outer edges of the second openings 39. The second shield parts 40 have the same structure as the first shield parts 28. The first resin housing 4a is a housing corresponding to the first resin housing 4 of the first embodiment, but having an opening 43.

The length from the outer edge of the first shield part 28 provided on the outer edge of each of the two first openings 27 in the top face part of the first connector housing 2b to the inside of the first connector housing 2b is such a length that can cover the communication signal lines 5. In a similar manner, the length from the outer edge of the second shield part 40 provided on the outer edge of each of the two second openings 39 in the top face part of the second connector housing 3b to the inside of the second connector housing 3b is such a length that can cover the communication signal lines 5.

Thus, the length from each of the outer edges of the first shield parts 28 to the inside of the first connector housing 2b is longer than the length from the top face part of the first connector housing 2b to each of the positions where the communication signal lines 5 are placed in the first connector housing 2b. The length from each of the outer edges of the second shield parts 40 to the inside of the second connector housing 3b is longer than the length from the top face part of the second connector housing 3b to each of the positions where the communication signal lines 5 are placed in the second connector housing 3b.

Because the connector 1D includes the first shield parts 28, the amount of propagation of radial noise, which is propagated from the outside of the connector 1D to the inside of the first connector housing 2b via the first openings 27, to the communication signal lines 5 is able to be reduced as compared with the amount of propagation in the fourth embodiment. Because the connector 1D includes the second shield parts 40, the amount of propagation of radial noise, which is propagated from the outside of the connector 1D to the inside of the second connector housing 3b via the second openings 39, to the communication signal lines 5 is able to be reduced as compared with the amount of propagation in the fourth embodiment.

Note that the first shield parts 28 need not be perpendicular to the top face of the first connector housing 2b. For example, in a case where the first connector housing 2b is produced from one metal sheet, the first shield parts 28 need not be bent at right angle from the top face of the first connector housing 2b. The second shield parts 40 need not be perpendicular to the top face of the second connector housing 3b. For example, in a case where the second connector housing 3b is produced from one metal sheet, the second shield parts 40 need not be bent at right angle from the top face of the second connector housing 3b. Only either of the first shield parts 28 and the second shield parts 40 may be provided.

### Sixth Embodiment

FIG. 15 is a perspective view schematically illustrating a connector 1E according to a sixth embodiment. FIG. 16 is an exploded perspective view of the connector 1E according to the sixth embodiment. FIG. 16 schematically illustrates a state in which the connector 1E is decomposed. The connector 1E includes a first connector housing 2c, a second connector housing 3c, the first resin housing 4, and a second resin housing 8.

The first connector housing 2c has the same structure as the first connector housing 2 in the first embodiment. The first connector housing 2c is larger than the second resin housing 8. The second connector housing 3c has the same structure as the second connector housing 3 in the first embodiment. The second connector housing 3c is larger than the first resin housing 4, and smaller than the first connector housing 2c. A capacitor connection opening 81 is formed in a side face of the second resin housing 8.

In the sixth embodiment, the first resin housing 4 is covered by the second connector housing 3c. The second resin housing 8 is larger than the second connector housing 3c, and covers the second connector housing 3c. The second resin housing 8 is smaller than the first connector housing 2c, and is covered by the first connector housing 2c. The second resin housing 8 preferably has a thickness that can electrically insulate the first connector housing 2c and the second connector housing 3c from each other.

The capacitor connection opening 81 formed in the second connector housing 3c enables a jig for attaching the first capacitor 6a onto the first connector housing 2c and the second connector housing 3c to be inserted into the second connector housing 3c.

As described above, in the connector 1E according to the sixth embodiment, the second resin housing 8 covers the second connector housing 3c, and is covered by the first connector housing 2c. Thus, the second connector housing 3c is covered by the first connector housing 2c with the second resin housing 8 therebetween.

The connector 1E is therefore capable of reducing the amount of noise propagated from the outside of the connector 1E to the second connector housing 3c as compared with the amount of noise propagated to the second connector housing 3 in the first embodiment. For example, the noise is noise of static electricity generated when a human touches the connector 1E or the connector 1. The connector 1E is therefore capable of making the amount of noise propagated from the first connector housing 2c to the signal ground pattern 53 via the second connector housing 3c smaller than the amount of noise propagated to the signal ground pattern 53 in the case of the first embodiment.

### Seventh Embodiment

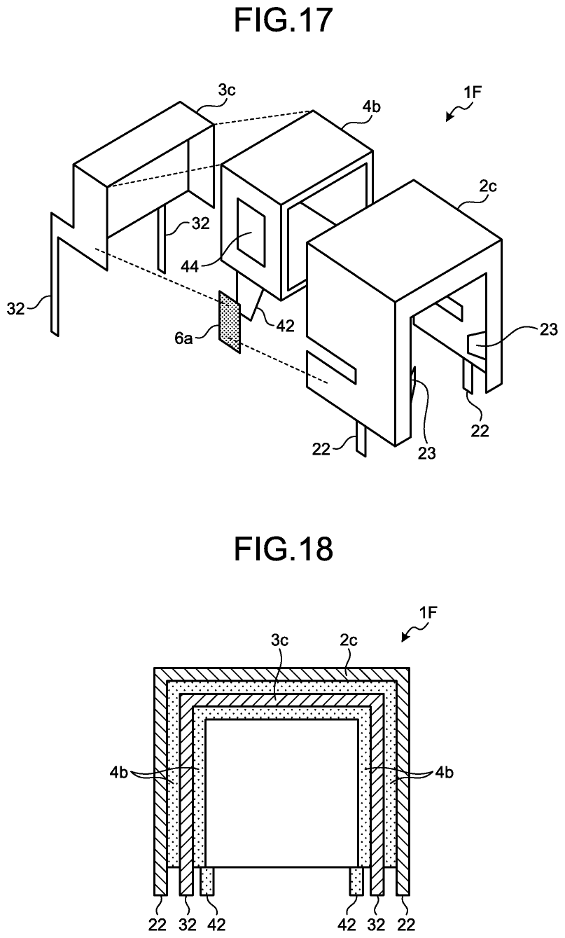

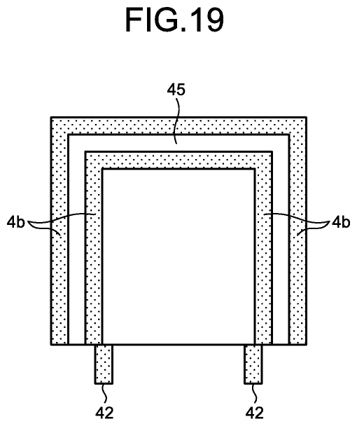

FIG. 17 is an exploded perspective view of a connector 1F according to a seventh embodiment. FIG. 17 schematically illustrates a state in which the connector 1F is decomposed. FIG. 18 is a diagram schematically illustrating a front of the connector 1F according to the seventh embodiment. FIG. 19 is a diagram schematically illustrating a rear of the first resin housing 4b of the connector 1F according to the seventh embodiment. The connector 1F includes the first connector housing 2c and the second connector housing 3c, which are included in the connector 1E according to the sixth embodiment. The second connector housing 3c of the seventh embodiment, however, is smaller than the second connector housing 3c of the sixth embodiment. The connector 1F further includes a first resin housing 4b.

A capacitor connection opening 44 is formed in a side face of the first resin housing 4b. The capacitor connection opening 44 enables a jig for attaching the first capacitor 6a onto the first connector housing 2c and the second connector housing 3c to be inserted into the first resin housing 4b. The first resin housing 4b has an opening 45 of the same size as the second connector housing 3c along the thickness direction of the first resin housing 4b. The second connector housing 3c is located in the opening 45. In other words, the second connector housing 3c is accommodated in the opening 45 of the first resin housing 4b. The first connector housing 2c is larger than the first resin housing 4b. The first resin housing 4b is covered by the first connector housing 2c.

As described above, in the connector 1F according to the seventh embodiment, the second connector housing 3c is accommodated in the opening 45 of the first resin housing 4b, and the first resin housing 4b is covered by the first connector housing 2c. Thus, the second connector housing 3c is covered by the first connector housing 2c with the first resin housing 4b therebetween. The connector 1F is therefore capable of reducing the amount of noise propagated from the outside of the connector 1F to the second connector housing 3c as compared with the amount of noise propagated to the second connector housing 3 in the first embodiment, in a manner similar to the connector 1E according to the sixth embodiment.

The connector 1F according to the seventh embodiment does not include the second resin housing 8, which is included in the connector 1E according to the sixth embodiment. The connector 1F is therefore capable of producing the effects produced by the connector 1E with fewer components than the connector 1E has.

The configurations presented in the embodiments above are examples of the present invention, and can be combined with other known technologies or can be partly omitted or modified without departing from the scope of the present invention.

### REFERENCE SIGNS LIST

1, 1A, 1B, 1C, 1D, 1E, 1F connector; 2, 2a, 2b, 2c first connector housing; 3, 3a, 3b, 3c second connector housing; 4, 4a, 4b first resin housing; 5 communication signal line; 5a signal connection terminal; 6a first capacitor; 6b second capacitor; 7 capacitor connection board; 8 second resin housing; 21, 31, 41, 43, 45, 71a, 72a opening; 22 first connection terminal; 23 plug housing connection part; 24 contact terminal; 25 top face; 26 first capacitor connection part; 27 first opening; 28 first shield part; 32 second connection terminal; 33, 33a connection board; 34 transformer; 35 common mode choke coil; 36 second capacitor connection part; 37 third connection terminal; 38a first communication signal line opening; 38b second communication signal line opening; 39 second opening; 40 second shield part; 42 projection; 44 capacitor connection opening; 51 circuit board; 52, 71 frame ground pattern; 53, 72 signal ground pattern; 54 integrated circuit; 55 first fastening member; 56 second fastening member; 61 face; 81 capacitor connection opening; 98 communication cable plug; 99 plug housing part.

1. A connector comprising:
a first connector housing including a plug housing connection with which a plug housing of a communication cable plug is to be connected, a first connection terminal connected with a frame ground pattern on a circuit board, and a first capacitor connection section located closer to the plug housing connection than a top face, the first connection terminal being disposed on the first capacitor connection section;
a transformer or a common mode choke coil;
a second connector housing separated from the first connector housing and including a second connection terminal connected with a signal ground pattern on the circuit board, and a second capacitor connection section located closer to the second connection terminal than a position where the transformer or the common mode choke coil is placed, the second connection terminal being disposed on the second capacitor connection section; and
a first capacitor to connect the first capacitor connection section of the first connector housing with the second capacitor connection section of the second connector housing, wherein
the top face is a top face of the first connector housing, and
the transformer or the common mode choke coil is located inside the second connector housing.

2. The connector according to claim 1, further comprising:
one or more capacitors to connect the first connector housing with the second connector housing.

3. The connector according to claim 1, further comprising:
a connection board located inside the second connector housing, including a third connection terminal with which the second connector housing is connected, and having a first communication signal line opening and a second communication signal line opening with which signal connection terminals of communication signal lines on the circuit board are connected, wherein
a distance between the third connection terminal and the first communication signal line opening is equal to a distance between the third connection terminal and the second communication signal line opening.

4. The connector according to claim 1, wherein
the first connector housing further includes a communication signal line, and
the first connector housing has a first opening at a position between a position where the communication signal line is placed and a position where the plug housing connection is placed.

5. The connector according to claim 4, wherein
the first connector housing further includes a first shield extending from an outer edge of the first opening into an inside of the first connector housing.

6. The connector according to claim 1, wherein
the second connector housing further includes a communication signal line, and
the second connector housing has a second opening at a position between a position where the communication signal line is placed and the second capacitor connection section.

7. The connector according to claim 6, wherein
the second connector housing further includes a second shield extending from an outer edge of the second opening into an inside of the second connector housing.

8. The connector according to claim 1, further comprising:
a first resin housing covered by the second connector housing; and
a second resin housing covering the second connector housing and being covered by the first connector housing.
